(19) United States
(12) Patent Application Publication
(10) Pub. No.: US 2026/0019107 A1
(43) Pub. Date: Jan. 15, 2026

(54) A SELF-ORGANIZING MULTI-DIRECTIONAL ANTENNA SYSTEM FOR MULTIPLE RADIO BASE STATIONS TO AGGREGATE NETWORK CAPACITY IN A HOTSPOT

(71) Applicant: Dimitris KOLOKOTRONIS, Athens (GR)

(72) Inventor: Dimitris KOLOKOTRONIS, Athens (GR)

(21) Appl. No.: 18/995,413

(22) PCT Filed: Jul. 18, 2023
(86) PCT No.: PCT/EP2023/069947

§ 371 Date: Jan. 16, 2025

(30) Foreign Application Priority Data
Jul. 18, 2022 (GB) 2210526.6

(51) Int. Cl. H04B 7/022; H04B 7/155; H04B 7/26; H04W 16/26

(52) U.S. Cl. CPC H04B 7/022; H04B 7/155; H04B 7/2606; H04W 16/26

(57) ABSTRACT

A multi-directional antenna system (10) for a hotspot (30), the system having a plurality of directional donor antennas (12, 22), each antenna oriented in a different direction such that each antenna has a different dominant radio base station in use. A plurality of intermediary devices (14, 24) are provided wherein each directional donor antenna is connected to a respective different intermediary device and each intermediary device is configured to retransmit the respective signals of each different dominant radio base station to provide service to a plurality of users within the hotspot.

### TECHNICAL FIELD

This invention relates to a self-organizing multi-directional antenna system for deployment on a static or on a moving hotspot. In particular, this invention relates to a self-organizing multi-directional antenna system that simultaneously re-transmits a plurality of radio base stations to the hotspot, as such to leverage the available radio base station resources and offer higher network capacity at the hotspot location. To achieve higher network capacity, each directional antenna of the multi-directional antenna system self-configures to target the appropriate radio base station as such each to become dominant. Using intermediary devices such as RF repeaters and wireless modems, positioned between the multi-directional antenna system and the hotspot users requesting voice and data telecommunication services.

### BACKGROUND ART

Wireless telecommunication networks, such as LTE, WiFi, 5G technology and beyond, offering service to mobile phones and other connected devices, typically comprise a plurality of radio base stations (RBS), each of which has at least one antenna (cell) mounted thereon. Each antenna or cell best serves/best covers (i.e., it presents the highest signal strength level as received from the connected devices) a geographical segment or sector area. Inside the sector area several mobile phones and other connected devices are randomly distributed in time and locations, where some are formed in hotspots. It is known that at one location several radio base stations have a receivable signal (i.e., the signal strength reception has higher level than the connected device receiver sensitivity level), although only one is dominant (i.e., the dominant radio base station has higher signal strength than other radio base stations having receivable signal in the sector area). On broadband wireless technologies, only the dominant radio base station offers service to mobile phones and other connected devices, while the rest of the radio base stations having receivable signal are considered interference or neighbouring radio base stations.

By “hotspot” we mean a confined geographical area containing multiple connected devices that are requesting service directly from the wireless telecommunication network or via an intermediary device. Hotspots can be static (indoor or outdoor) or moving in the wireless telecommunication network coverage footprint. Examples of static indoor hotspots are homes, offices, hotels, factories, restaurants, airports, malls and the like. Examples of static outdoor hotspots are stadiums, beaches, outdoor coffee shops, clubs, restaurants and the like. Examples of moving hotspots are ships, buses, trains, tracks, cars and the like.

By intermediary devices we mean RF repeaters, rebroadcast antennas, distributed antenna systems, wireless modems, modem-routers, access points (APs), internet bundling/bonding devices, small- micro-, pico-, or femto-RBS cells (that use for backhauling the same wireless network) or other appropriate devices that may be used for re-transmission of the wireless network radio base stations on the hotspot. The intermediary devices provide the means for the user equipment on the hotspot to connect to the radio base stations (in its initial form i.e. LTE radio base station to LTE user equipment, WiFi radio base station to WiFi user equipment or other form i.e. LTE radio base station to WiFi user equipment, WiFi radio base station to LTE user equipment) leveraging the available radio base station resources as such to provide optimum connectivity for the users on the hotspot.

A “hotspot” may be a high traffic or low traffic hotspot. An example of a low traffic hotspot is a single house, a small office, a small retail store, a restaurant, a small vessel, a bus or car (in such a hotspot the telecommunications network operator/provider primary objective is to offer connectivity/coverage). Examples of a high traffic hotspot is a hospital, a hotel, apartment complexes and convention centres, airports, malls, manufacturing facilities or ferries such as a RoPax Ferry carrying 2000 passengers (in such a hotspot the telecommunications network operator/provider objective is two-fold, to offer both network connectivity/coverage and also network capacity in order to cope with the hotspot's high traffic demand).

In order to address weak or poor radio signal reception as such to tackle connectivity/coverage issues, RF repeater systems are often used. An RF repeater (also known as radio signal booster or amplifier), is a system used for boosting the radio signal in indoor or remote areas such as buildings, tunnels, ships and the like. Since RF repeaters are used to amplify and further re-transmit radio base station (RBS) signals to mobile phones and other connected devices are herein considered as intermediary devices. An RF repeater system generally comprise three main functional units: a donor external antenna (directional or omnidirectional), a signal (usually bi-directional) amplifier, and an internal rebroadcast antenna or a distributed antenna system. The RF repeater amplifies and re-transmits the received radio signal in its initial form and technology. The radio signals after amplification may be re-transmitted to a selected RF coverage zone (indoor or outdoor) by using a rebroadcast antenna or a distributed antenna system.

The problem of using RF repeaters is that they amplify and re-transmit any radio signal received at their input after adding equal gain to all. Irrespective of whether they use directional or omnidirectional antennas as donor, an RF repeater always outputs a single dominant radio base station (i.e. a single radio base station of the plurality received at the repeater's input will have higher signal strength than its neighbours). This means that an RF repeater will always amplify and re-transmit a single dominant RBS cell to its rebroadcast antenna or a distributed antenna system serving a hotspot. Due to this single dominant RBS-cell that is amplified and re-transmitted from the RF repeater, all hotspot users served by the rebroadcast antenna or a distributed antenna system will share the same frequency resource (as they will connect on this dominant cell), not only between them but also among the users that are served by the dominant cell outside the hotspot area. This is the main reason that RF repeaters are only considered as coverage boosters and are not deployed for capacity purposes. Therefore, they are considered ideal solutions for connectivity and coverage problems that low traffic hotspots present but are not considered optimum for use on high traffic hotspots that on top of coverage may also have capacity problems.

The applicant's granted patent EP3228023B1 provides a partial solution to the RF repeater capacity limitation problem. In this patent, a plurality of scanning and donor antennas is provided, the scanning antennas continuously scan for the best radio signal conditions available in the geo area. This information is used to select a directional (high gain) donor antenna out of the plurality, the one providing the optimum signal to feed the RF repeater. In this way, the hotspot can always receive the best available RBS signal at any given location with low interference from neighbouring RBS-cells. Increasing the signal to noise and interference ratio of the formed radio link between the donor RBS-cell and the RF repeater in use on the hotspot (by increasing the selected donor RBS-cell signal receptions and by suppressing the interfering signals from the neighbouring RBS-cells due to the use of directional antennas) significant capacity gains (although depending on SINR improvement) are achieved on the hotspot (RBS-cell capacity fully depends on the SNIR of the respective radio links formed between the RBS-cell and the radio terminal devices). However, when the mobile traffic generated on the hotspot is very high (i.e. two-fold the available capacity of the RBS-cell), the system selected donor RBS-cell frequency resource is not adequate (the donor RBS-cell becomes bandwidth limited).

The problem with prior art is that it always re-transmits a single radio base station, the one with the best radio conditions, irrespective the traffic this single radio base station carries and is required to carry adding the hotspot traffic. When the system described by the prior art is applied to a high traffic hotspot, although it uses a multi-directional antenna system, the re-transmitted radio base station (depending on traffic load) may congest due to lack of bandwidth.

Network congestion refers to a situation in which the demand for network resources, such as bandwidth or processing capacity, exceeds the available capacity of the network infrastructure (i.e. in this case the re-transmitted radio base station capacity). It typically occurs when there is an excessive amount of data being transmitted through the network (i.e. when adding the traffic load generated from the high traffic hotspot), leading to delays, packet loss, and degraded performance for all users connected to the radio base station serving the hotspot. The consequences of network congestion include increased latency (delays), decreased throughput (reduced data transfer rate), packet loss (data packets being dropped), and (depending on radio transmission technology) even total connectivity loss. These issues can negatively impact user experience, particularly for real-time applications such as video streaming, online gaming, or VolP (Voice over Internet Protocol) calls. Except high traffic, other factors can contribute to network congestion on a hotspot, including network bottlenecks (where certain points in the network may also have limited capacity creating bottlenecks where congestion can occur more easily-an example is the installation of a small- micro-, pico-, or femto-RBS cell with an inadequate backhauling capacity) and network topology (where the layout and design of the network can impact its ability to handle traffic efficiently, i.e. a high interference area where multiple radio base stations have receivable signal at the same levels of the dominant radio base station).

In order to address weak or poor radio network capacity on a hotspot, telecommunication network operators/providers install one or more radio base station (RBS) dedicated to that hotspot. These are usually called small- micro-, pico-, or femto-RBS (or small-, micro-, pico-, or femto-cells). By installing such an RBS type, the hotspot enjoys a dedicated frequency resource (i.e. is not shared with users outside the hotspot) which results in significant network capacity increase for both the hotspot users and the non-hotspot users (offloads the cellular traffic and consecutively also boosts the network radio base station efficiency). However, installing small-, micro-, pico-, or femto-cells is an expensive solution for the telecommunication network operator/provider in terms of both capex and opex (although such cells are cheaper than conventional radio base stations still involve the addition of separate active nodes on the network), can only be planned, installed and maintained by the telecommunication network operator/provider specialized personnel (adding significant burden to the network roll-out activities), while they require an uninterrupted broadband internet connection (i.e. optical fibre or other) to the core mobile network via a wired or wireless backhaul process (backhauling performance, when does not achieve targeted transmission rates, affects the small-, micro-, pico-, or femto-cell capacity as previously mentioned).

Important to note here that due to the needed backhaul connection to the core mobile network, small-, micro-, pico-, or femto-cells are not considered ideal for deployment on moving hotspots (i.e. ferry boats, trains or buses). Since such hotspots are on continuous move, to achieve uninterrupted broadband internet connection for backhauling purposes on such vehicles is expensive (i.e. by using a high capacity satellite link) and generally problematic. For all above reasons, adding a radio base station such as a small-, micro-, pico-, or femto-cell especially on a moving hotspot is undesirable.

A wireless modem or modem-router, such as a 4G/5G/WiFi router, is a networking device that combines the functionality of a modem and a router specifically for wireless network connectivity. Unlike traditional modem routers that rely on wired connections like cable or DSL, a wireless modem router uses a wireless network to connect to the internet. The wireless modem component of the router is responsible for connecting to a wireless network provided by a wireless network operator. It may contain a SIM card slot to insert a SIM card (if cellular) or other user identification component, which provides the necessary credentials to access the wireless network (if IEEE 802.11 family and the like). The modem (using an antenna) establishes a wireless connection to the network radio base station and enables communication between the local network (i.e., the network deployed on hotspot) and the wireless network. Since modems are used to further re-transmit radio base station (RBS) signals to mobile phones and other connected devices are herein considered as intermediary devices. The router component of a wireless modem router functions similarly to a traditional router. It allows multiple devices on the local network to connect to the wireless network and share the internet connection. It provides local IP addresses, manages network traffic, and enables communication between devices within the network and with devices on the internet.

Wireless modem routers often include Ethernet ports for wired connections and built-in Wi-Fi capabilities to create a wireless network for the connected devices. These wireless modem routers typically support different wireless network technologies, such as 4G LTE, WiFi or 5G, depending on the model used and the network availability in the area to be used. Several wireless modem routers may be connected to a bundling or bonding device to combine multiple internet connections into a single connection with increased bandwidth and reliability.

Referring to FIGS. 1a and 1b, typical prior art apparatuses are shown.

In each Figure a cellular radio network comprises a plurality of radio base stations RBS₁ to RBS_{N}.

The prior art apparatus 1 of FIG. 1a comprises an antenna 3 (which may be omni-directional or directional), an intermediary device in the form of an RF repeater 5 and a rebroadcast antenna array 7 serving a hotspot 9.

The prior art apparatus 2 of FIG. 1b comprises an antenna 4 (which may be omni-directional or directional), an intermediary device in the form of a modem 6 connected to an access point 8 serving a hotspot 10.

In each embodiment, the antenna 3, 4 will connect to the RBS with the strongest signal-the dominant RBS. The other RBSs in range will only acts as interferers. The antenna 3, 4 in reality has only one option for connection-the dominant RBS. If it connects to a non-dominant RBS then the SINR will drop below zero, detrimentally affecting the system's ability to serve the hotspot.

It is an aim of the present invention to overcome, or at least mitigate, the aforementioned network capacity/congestion problems, especially on moving hotspots.

The present invention achieves this aim by utilising the interferer, non-dominant or neighbouring radio base stations for capacity boost purposes at the hotspot.

### SUMMARY OF INVENTION

According to the first aspect of the invention there is provided a multi-directional antenna system for a hotspot, the system comprising:
a plurality of directional donor antennas, each antenna oriented in a different direction such that each antenna has a different dominant radio base station in use;
a plurality of intermediary devices;
wherein:
each directional donor antenna is connected to a respective different intermediary device; and,
each intermediary device is configured to retransmit the respective signals of each different dominant radio base station to provide service to a plurality of users within the hotspot.

Advantageously, the present invention overcomes the hotspot capacity problem by aggregating the bandwidth of multiple radio base stations in the hotspot. The plurality of dominant radio base stations in the hotspot enables better utilization of the wireless network resources including infrastructure, frequency and bandwidth.

In a first use case, the intermediary devices are repeaters. Each of the plurality of repeaters may be connected to a respective rebroadcast antenna or distributed antenna system, wherein each rebroadcast antenna or distributed antenna system covers a different area of the hotspot. According to the present invention a multi-directional antenna system is configured to connect to a plurality of RF repeater systems that simultaneously re-transmit a plurality of different dominant network radio base stations (donor in this case) via respective rebroadcast antenna systems or distributed antenna systems, designed and planned to offer RF coverage to a plurality of distinct area zones, in a static or moving hotspot. Advantageously, the capacity of multiple radio base stations is aggregated, by using multiple RF repeaters (considered herein as intermediary devices), that load balance the hotspot's generated traffic.

We define this use case of radio base station capacity aggregation as multi-zone aggregation. The system utilises multiple directional antennas connected to multiple RF repeaters which in turn are connected to multi-rebroadcast antenna or multi-distributed antenna system, each rebroadcast antenna or distributed antenna system covering a discrete non-overlapping area on the hotspot. It requires careful hotspot area RF planning in order each rebroadcast antenna or distributed antenna system to minimally RF overlap one to another to avoid in-hotspot interference.

In a second use case, the intermediary devices are modems. Each of the plurality of modems may be connected to a respective WiFi access point, wherein each WiFi access point covers a different or the same area of the hotspot. According to the present invention a multi-directional antenna system is configured to connect to a plurality of wireless modems, wherein via a plurality of WiFi access points that simultaneously re-transmit the plurality of different dominant network radio base stations on different transmission frequencies, leveraging the different dominant network radio base stations to provide higher network capacity and accommodate more devices. Using different transmission frequencies, allows the WiFi access points to use adjacent or non-overlapping WiFi channels simultaneously to increase the overall data capacity and throughput in a static or moving hotspot.

In an exemplary configuration, multiple directional antennas are connected to multiple respective wireless modem-routers offering multiple access points at the same or different areas on the hotspot. For example two directional antennas may be connected to two wireless modem-routers, each modem-router further connecting to a respective access point, one at 2.4 GHz and one at 5 GHz. The hotspot areas may be coincident, overlapping or non-overlapping. A Wi-Fi access point typically transmits signals on one or more frequencies within the Wi-Fi frequency bands. Wi-Fi operates in the 2.4 GHz and 5 GHz frequency bands, and these bands are further divided into channels. In the 2.4 GHz band there are 14 channels available. However, due to overlapping and interference concerns, in most countries, only three non-overlapping channels (1, 6, and 11) are used to minimize interference between neighbouring Wi-Fi networks. For example three directional antennas may be connected to three wireless modem-routers, each modem-router further connecting to a respective access point, all at 2.4 GHz band, wherein the first access point configured to transmit at channel 1, the second access point configured to transmit at channel 6 and the third access point configured to transmit at channel 11.

In the 5 GHz band, there are significantly more channels available for Wi-Fi use. The exact number of available channels can vary depending on the country and the specific Wi-Fi standard being used (such as Wi-Fi 4, 5, or 6). In general, the 5 GHz band offers multiple non-overlapping channels, allowing for greater channel selection and reduced interference compared to the 2.4 GHz band. Deploying the exemplary system on a hotspot, several directional antennas may be connected to several wireless modem-routers in which the several wireless modem-routers may be further connected to several access points, wherein the access points may be configured to different bands and channels to aggregate radio base station capacity on static or moving hotspot.

Another way to aggregate the multiple radio base station capacity on a hotspot is to provide a bundling or bonding internet device. The bundling or bonding device combines the bandwidth of the individual connections into a single connection. This aggregation increases the overall bandwidth available for data transfer. For example, if there are two radio base stations of 50 Mbps connection each, a bundling device can combine them to provide a single connection with a theoretical total bandwidth of 100 Mbps. In addition to increased bandwidth, bundling devices often offer redundancy and failover capabilities. If one of the connections fails or experiences instability, the device can automatically route traffic through the remaining functional connections, ensuring uninterrupted connectivity. By bundling or bonding the capacity of multiple radio base stations, these devices provide improved speed, increased reliability, and enhanced performance for activities that require high bandwidth.

According to the present invention a multi-directional antenna system is configured to connect to a plurality of wireless modems that simultaneously re-transmit a plurality of different dominant network radio base stations via appropriate bundling or bonding devices as such to aggregate the capacity/channel bandwidth of the different dominant network radio base stations, in a single connection with increased bandwidth and reliability for i.e. backhauling small- micro-, pico-, or femto-RBS cell purposes in a static or moving hotspot. Advantageously, the capacity of multiple radio base stations is aggregated, by using bundling or bonding devices (considered herein as intermediary devices), that may provide the backhauling capacity and reliability needed to deploy small- micro-, pico-, or femto-RBS cell especially on a moving hotspot.

Preferably the radiation pattern of each of the directional donor antennas is configured to be independently steered. This may be achieved with mechanical or electromechanical means.

Preferably the system comprises a controller configured to control each of the directional donor antennas to direct each to a different radio base station.

Preferably the system comprises:
a scanning antenna configured to identify a suitable radio base station for each of the plurality of directional donor antennas to connect to.

The scanning antenna may have a wider horizontal beamwidth than each of the directional donor antennas, for example the scanning antenna may be an omnidirectional antenna.

Alternatively, the scanning antenna may be a direction antenna that is configured to be steered to scan the surrounding area.

Alternatively, a plurality of direction scanning antennas may be provided, each in a different direction (for example four scanning antenna at 90 degrees).

The scanning antenna may be, for example, of the same configuration as the applicant's previous application EP3228023.

Where the scanning antennas are directional, their heading can be used to infer the heading of the RBS, and as such the RBS location lookup function may not be required.

Preferably the scanning antenna is connected to a scanning device, cellular chip, SIM card or eSIM.

Preferably the controller is connected to a database of RBS locations, and is configured to obtain the location of each RBS based on information provided from the scanning antenna.

Preferably the controller comprises a veto list wherein selected RBSs are vetoed.

Preferably the system comprises a locator for determining the position of the system.

Preferably the position of the system is updated periodically, and wherein the controller is provided with an updated position of the system.

Preferably the system comprises:
an omnidirectional donor antenna; and,
a switching sub-system configured to switch at least one of the intermediary devices between its respective directional donor antenna and the omnidirectional donor antenna.

This invention also relates to a multi-directional antenna system that utilizes a dynamic switching system selecting between the plurality of directional antennas and/or a redundant directional or omnidirectional antenna (back-up). The purpose of the redundant directional or omnidirectional antenna is to offer uninterrupted coverage to the plurality distinct (ideally non-overlapping) RF coverage hotspot zones when the available (receivable) different dominant donor radio base stations at the hotspot location do not suffice to service all and each RF coverage hotspot zones (i.e. when each hotspot zone is serviced by a different dominant radio base station).

Specifically, the redundant directional or omnidirectional antenna, when using a scanning antenna and a scanner device capable to identify and locate the availability of radio base stations at the hotspot location, configured to automatically detect, evaluate and select from the plurality of radio base stations available (receivable) for re-transmission, donor antenna system between the multi-directional antenna system and the redundant directional or omnidirectional antenna.

Capacity according to the present invention may be boosted even when using RF repeaters. However, multiple RF repeaters have to be used, each one to have different donor radio base station aggregated in different forms in the hotspot.

According to a second aspect of the invention there is provided a method of operating a multi-directional antenna system for a hotspot comprising the steps of:
providing a plurality of directional donor antennas and a plurality of intermediary devices;
connecting each directional donor antenna to a respective different intermediary device;
using each of the plurality of directional donor antennas to target a different dominant radio base station;
using the intermediary devices retransmit each respective different radio base station to provide service to a plurality of users within a hotspot.

Preferably the intermediary devices are repeaters.

Preferably each of the plurality of repeaters is connected to a respective rebroadcast antenna or distributed antenna system, wherein each rebroadcast antenna or distributed antenna system covers a different area of the hotspot.

Preferably the intermediary devices are modems.

In one embodiment each of the plurality of modems is connected to a respective access point, wherein each access point covers a different area of the hotspot.

In an alternative embodiment each of the plurality of modems is connected to a respective access point, wherein each access point covers the same area of the hotspot.

Preferably the intermediary devices are LTE/5G/6G cellular chips providing ethernet or WiFi service to a plurality of users within the hotspot.

Preferably the method comprises the step of steering the radiation pattern of at least one of the directional donor antennas.

Preferably the method comprises the step of steering at least one of the directional donor antennas.

Preferably the method comprises the step of controlling each of the directional donor antennas to direct each to a different radio base station.

Preferably the method comprises the step of providing a scanning antenna having a wider horizontal beamwidth than each of the directional donor antennas, using the scanning antenna to identify a suitable radio base station for each of the plurality of directional donor antennas to connect to.

Preferably the scanning antenna is an omnidirectional antenna.

Preferably the scanning antenna is connected to a scanning device, cellular chip, SIM card or eSIM.

Preferably the controller is connected to a database of RBS locations, and is configured to obtain the location of each RBS based on information provided from the scanning antenna.

Preferably the controller comprises a veto list wherein selected RBSs are vetoed.

Preferably there is provided a locator for determining the position of the system.

Preferably the method comprises the step of periodically updating the position of the system; and, providing the controller with the updated position of the system.

Preferably the method comprises the step of providing an omnidirectional donor antenna; and, switching at least one of the intermediary devices between its respective directional donor antenna and the omnidirectional donor antenna.

Preferably the method comprises the step of switching at least one of the intermediary devices between its respective directional donor antenna and a directional donor antenna associated with another of the plurality of intermediary devices.

Preferably the method comprises the step of switching the at least one of the repeaters when either no signal is received at the associated directional donor antenna, or when a received signal does not meet a predetermined criteria.

Preferably the predetermined criteria is a receivable radio base station signal.

Preferably the rebroadcast antenna rebroadcasts the radio network capacity in its original form.

According to a third aspect of the present invention there is provided a cellular antenna repeater system for a vehicle, the system comprising a plurality of directional donor antenna sub-systems, each oriented in a different direction, and each connected to a respective rebroadcast antenna sub-system, wherein the re-broadcast antenna sub-systems each cover a different area of the vehicle.

By “direction” we mean direction in the global horizontal plane. Advantageously the present invention facilitates better coverage across a moving vehicle such as a ship by providing coverage via multiple donor antennas simultaneously. Therefore, multiple base stations can be used.

Preferably the areas of the vehicle do not overlap.

Preferably the system comprises:
an omnidirectional donor antenna sub-system; and,
a switching sub-system configured to switch at least one of the rebroadcast antenna sub-systems between the respective directional donor antenna sub-system and the omnidirectional donor antenna sub-system.

Preferably the switching sub-system is configured to switch each of the rebroadcast antenna sub-systems between the respective directional donor antenna sub-system and the omnidirectional donor antenna sub-system.

Preferably a splitter is provided between the omnidirectional donor antenna sub-system and the plurality of rebroadcast antenna sub-systems.

Preferably a controller is configured to control the switching sub-system, wherein a minimum signal quality criterion is established with respect to each of the donor antennas, and if the minimum signal quality criterion is not met, the controller controls the switching sub system to switch the appropriate rebroadcast antenna sub-system between the its directional donor antenna sub-system and the omnidirectional donor antenna sub-system.

According to a second aspect there is a method of operating a cellular antenna repeater system on a vehicle comprising the steps of:
providing a plurality of directional donor antenna sub-systems;
providing a plurality of a rebroadcast antenna sub-systems connected to each of the plurality of directional donor antenna sub-systems, wherein the re-broadcast antenna sub-systems each cover a different area of the vehicle;
connecting each of the plurality of donor antenna sub-systems to a different base station to provide coverage to each of the different areas of the vehicle.

Preferably the areas of the vehicle do not overlap.

Preferably the method has the steps of:
providing an omnidirectional donor antenna sub-system; and,
switching at least one of the rebroadcast antenna sub-systems between the respective directional donor antenna sub-system and the omnidirectional donor antenna sub-system.

Preferably the method comprises the step of switching each of the rebroadcast antenna sub-systems between the respective directional donor antenna sub-system and the omnidirectional donor antenna sub-system.

Preferably the method comprises the step of providing a splitter between the omnidirectional donor antenna sub-system and the plurality of rebroadcast antenna sub-systems.

Preferably the method comprises the step of:
establishing a minimum signal quality criterion with respect to each of the donor antennas; and,
if the minimum signal quality criterion is not met, controlling the switching sub system to switch the appropriate rebroadcast antenna sub-system between the its directional donor antenna sub-system and the omnidirectional donor antenna sub-system.

### BRIEF DESCRIPTION OF DRAWINGS

An embodiment of the present invention will now be described with reference to the following figure in which:

FIG. 1a is a schematic drawing of a first prior art apparatus;

FIG. 1b is a schematic drawing of a second prior art apparatus;

FIGS. 2a and 2b are schematic drawings of a first system according to the present invention;

FIGS. 3a to 3c are schematic drawings of a second system according to the present invention;

FIG. 4 is a schematic drawing of a third system according to the present invention;

FIGS. 5a and 5b are schematic drawings of a fourth system according to the present invention;

FIG. 5c is a schematic drawing of the system of FIG. 5a in a first state;

FIG. 5d is a schematic drawing of the system of FIG. 5a in a second state.

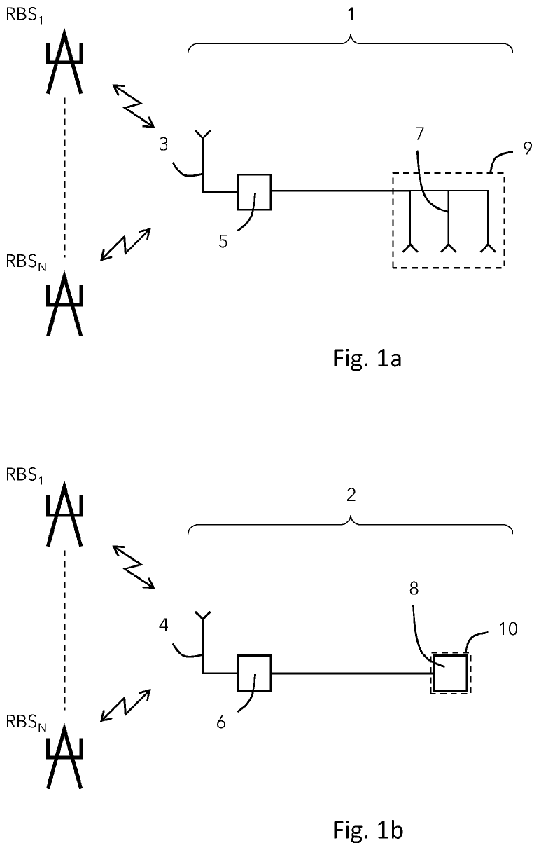

### DESCRIPTION OF THE FIRST EMBODIMENT

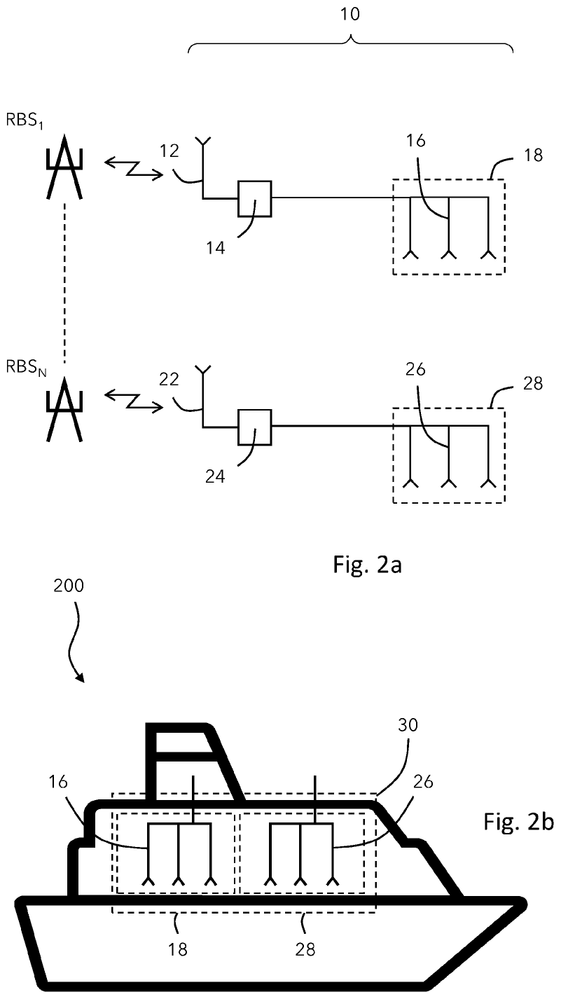

A system 10 according to the present invention is shown in FIGS. 2a and 2b.

A cellular radio network comprises a plurality of radio base stations RBS₁ to RBS_{N}.

The apparatus 10 of FIG. 2a comprises a first sub-system having directional antenna 12, an intermediary device in the form of an RF repeater 14 and a rebroadcast antenna array 16 serving a first zone 18. The apparatus 10 of FIG. 2a also comprises a second sub-system having directional antenna 22, an intermediary device in the form of an RF repeater 24 and a rebroadcast antenna array 26 serving a second zone 28.

Referring to FIG. 2b, the two zones 18, 28 cover distinct areas of the same hotspot 30. The areas are distinct. The hotspot shown in a ship, although it will be understood that other vehicles and static hotspots are possible.

In use, the two antennas 12, 22 are oriented in different directions such that each antenna's dominant RBS is different. For example, the antenna 12 may be pointed towards the RBS₁, and the antenna 22 towards RBS_{N}.

### Variations on the First Embodiment

Although the first embodiment is shown with RF repeaters and rebroadcast antennas, it will be understood that other types of intermediary devices may be employed such as modems and access points.

Although two sub-systems are shown, further sub-systems may be employed providing further capacity.

### Description of the Second Embodiment

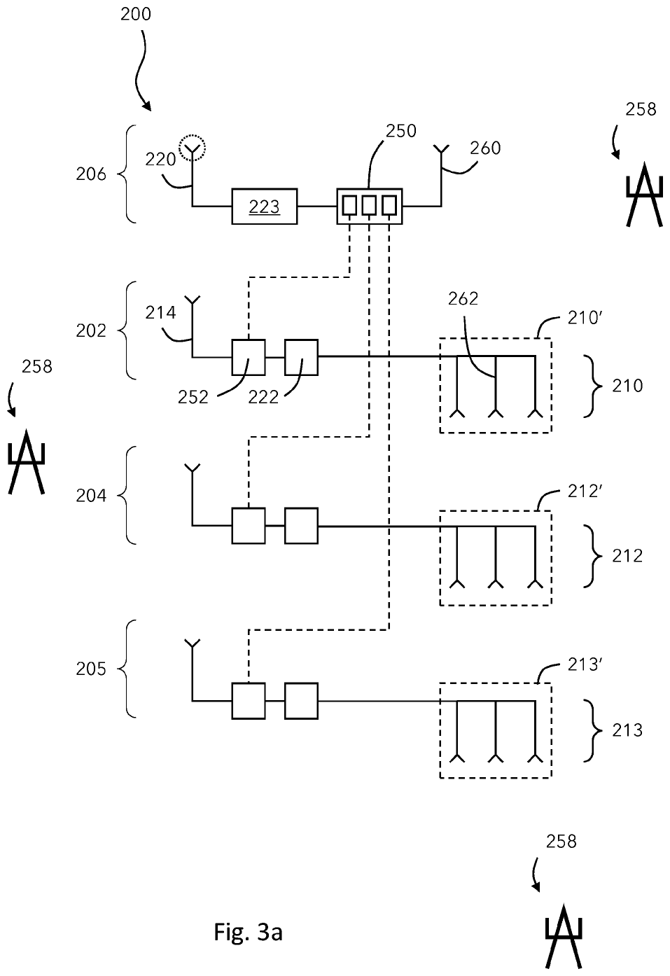

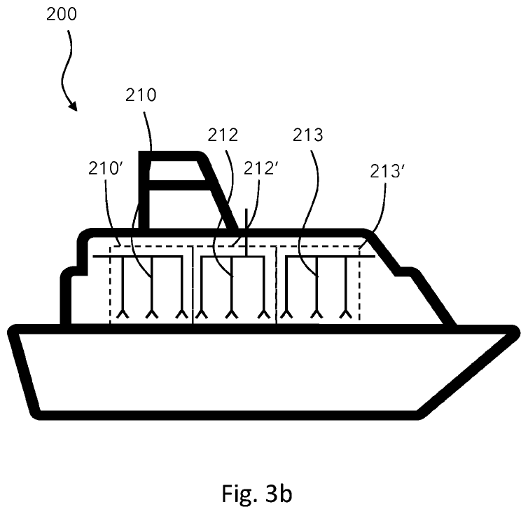

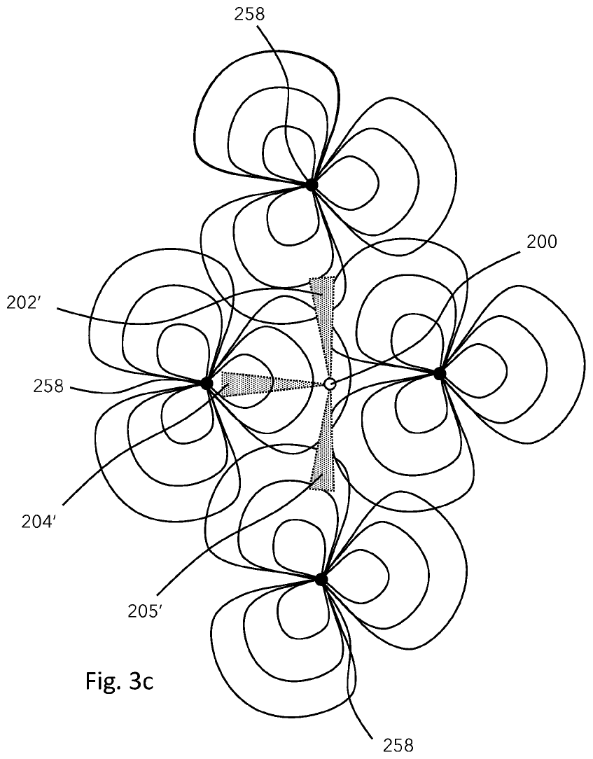

A system 200 according to the present invention is shown in FIGS. 3a to 3c.

### Configuration

The system 200 comprises a first directional donor antenna sub-system 202, a second directional donor antenna sub-system 204, a third directional donor antenna sub-system 205, an omni-directional scanning antenna sub-system 206, a controller 250, a first rebroadcast distributed antenna sub-system 210, a second rebroadcast antenna sub-system 212 and a third rebroadcast antenna sub-system 213.

The directional donor antenna sub-systems are substantially identical and as such only the sub-system 202 will be described. The sub-system 202 comprises a steerable directional antenna 214 having an actuator 252 configured to steer the antenna (in this embodiment) via electromechanical actuator in the azimuth plane. Each of the antennas is a directional antenna of narrow −3 dB horizontal beamwidth. Antennas could be S-Pol, X-pol, MIMO, massive-MIMO, active, multiband and the like.

The antenna 214 can be steered, in this embodiment, through 360 degrees. Each antenna 214 is connected to an RF repeater 222, which in this embodiment is part of a hotspot.

The omni-directional scanning antenna sub-system 206 comprises an omni-directional antenna 220 (covering 360 degrees) connected to a scanner 223. The scanner 223 comprises a device that connects to the available radio network using the omnidirectional antenna 220. The radio network comprises radio base stations (RBSs) 258.

The controller 250 receives an input from the device 223 and is configured to control each of the actuators 252.

Each rebroadcast antenna sub-system 210, 212, 213 comprises a plurality of rebroadcast antennas 262. Each sub-system 210, 212, 213 covers a discrete, non-overlapping area of the vehicle 210′, 212′, 213′ (in this case the ship of FIG. 3b).

### Use

In use, the omnidirectional antenna 220 connects to the network comprising RBSs 258. The controller 250 is connected to a GPS antenna 260 (or similar positioning device) that provides the controller with real-time coordinates for the location of the system.

The controller 250 determines the N best RBSs 258 and assigns each antenna 202, 204, 206 to a respective RBS. The “best” RBSs may be based on a number of qualities, including signal strength. The location of each RBS is either provided via the relevant data connection, or looked up in a local or remote database.

Each antenna is then steered to that RBS with the actuators 252. Referring to FIG. 3c, the radiation pattern 202′, 204′, 205′ of each respective sub-system 202, 204, 205 is directed to a different RBS 258.

The required heading of each antenna can be determined on the basis of RBS location (known) and system location (known from GPS). The heading of each antenna is adjusted to ensure that it is aligned to the RBS in real time, although it is within the scope of the invention for the controller 250 to select new RBSs as the system location and network conditions change.

### Description of the Third Embodiment

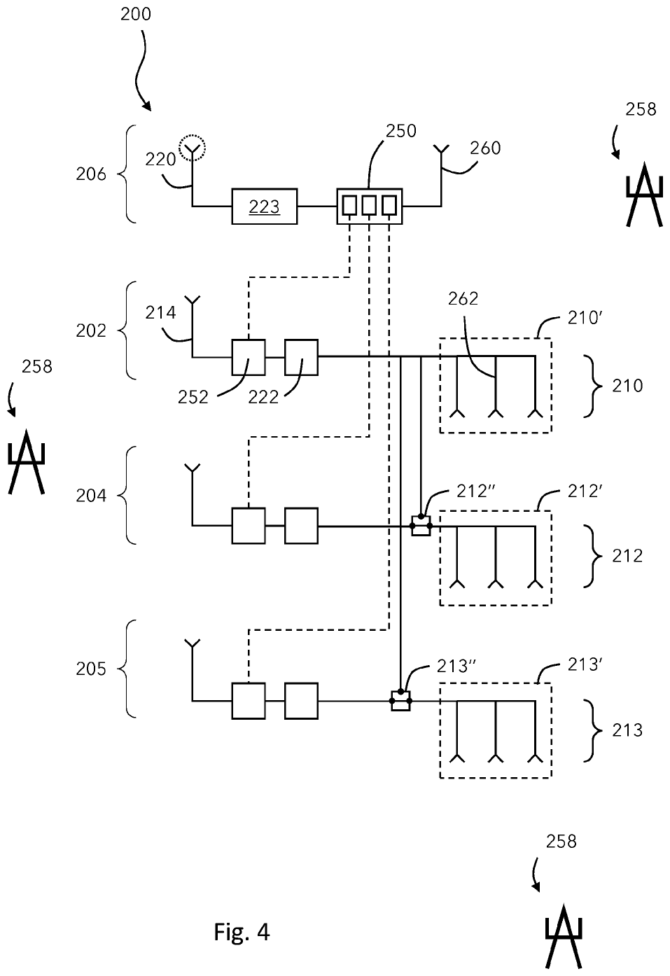

A further system according to the present invention is shown in FIG. 4. In this embodiment, similar features are numbered per the second embodiment and will not be described in detail here. In addition to these components, each of the rebroadcast antenna sub-systems 212, 213 is connected to a respective RF switch 212″, 213″. Each switch can move between two inputs-the respective donor antenna system 204, 205 and optionally the first donor antenna sub-system 202. This enables the system to move between one configuration in which each rebroadcast antenna system 210, 212, 213 is served by its own antenna 202, 204, 205 to a configuration in which all rebroadcast antenna sub-systems 210, 212, 213 are served by a single donor antenna 202. The controller 250 controls each of the switches 212″, 213″.

### Description of the Fourth Embodiment

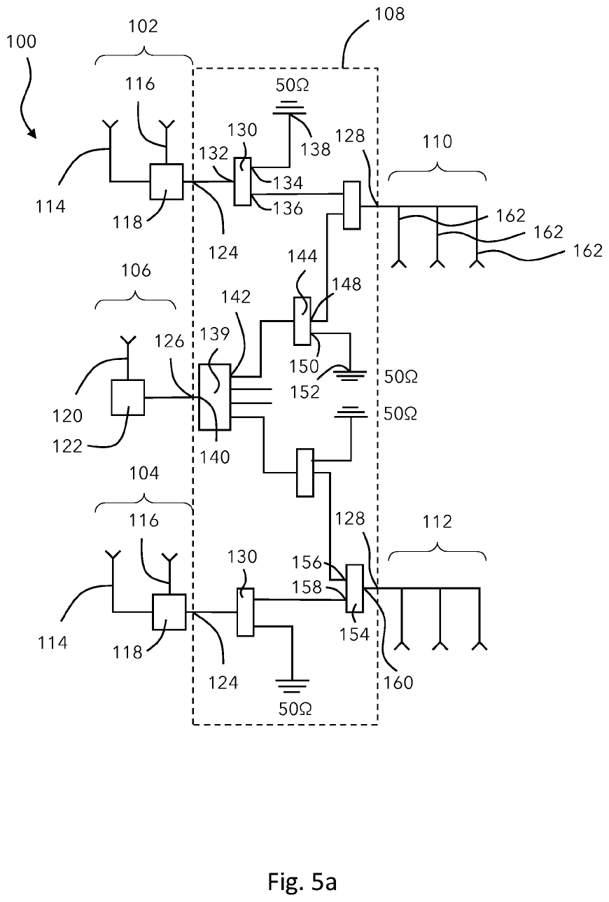

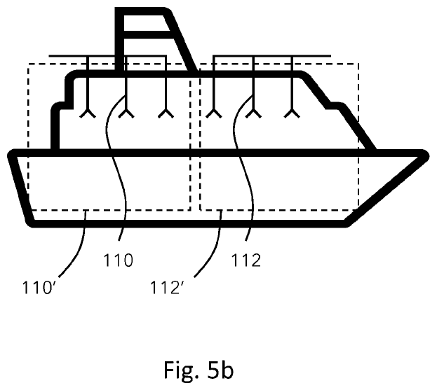

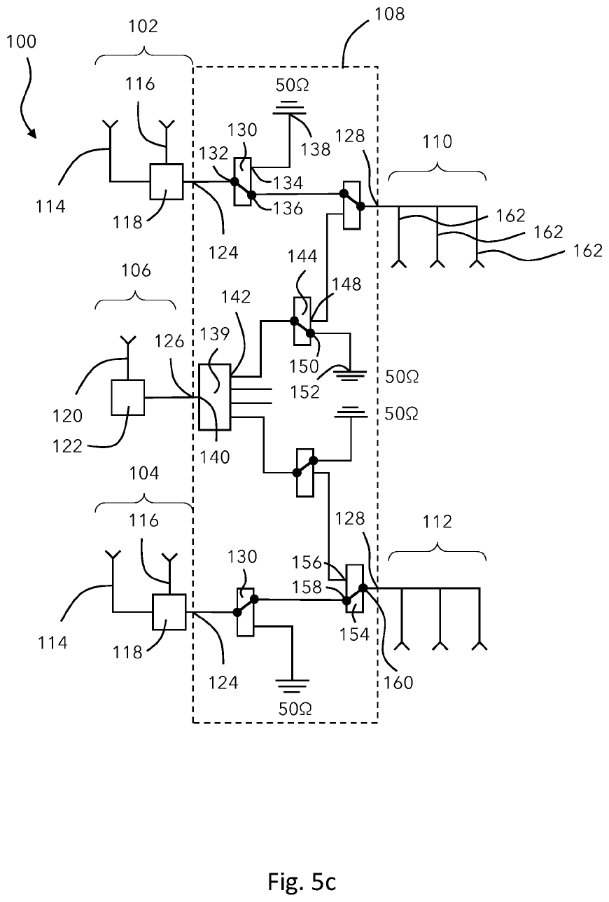

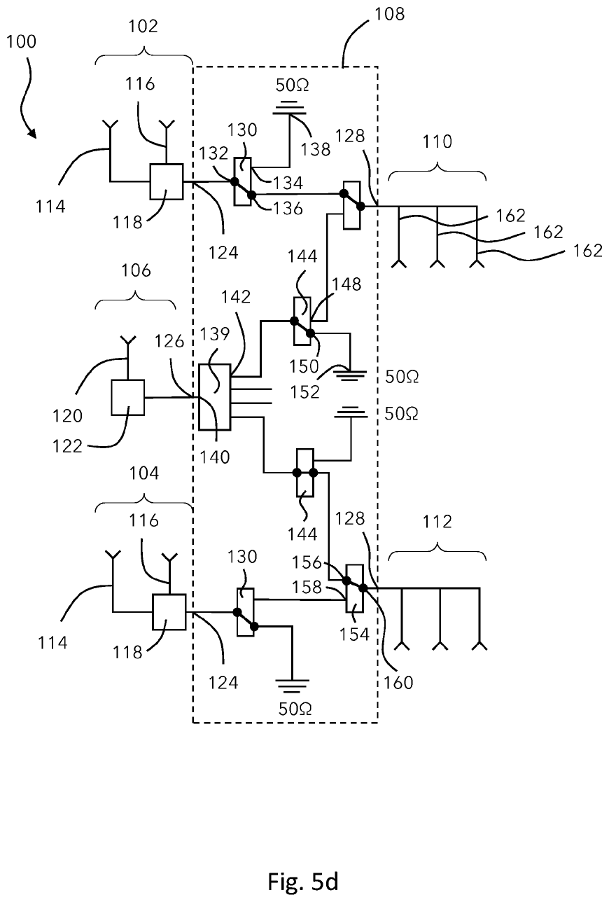

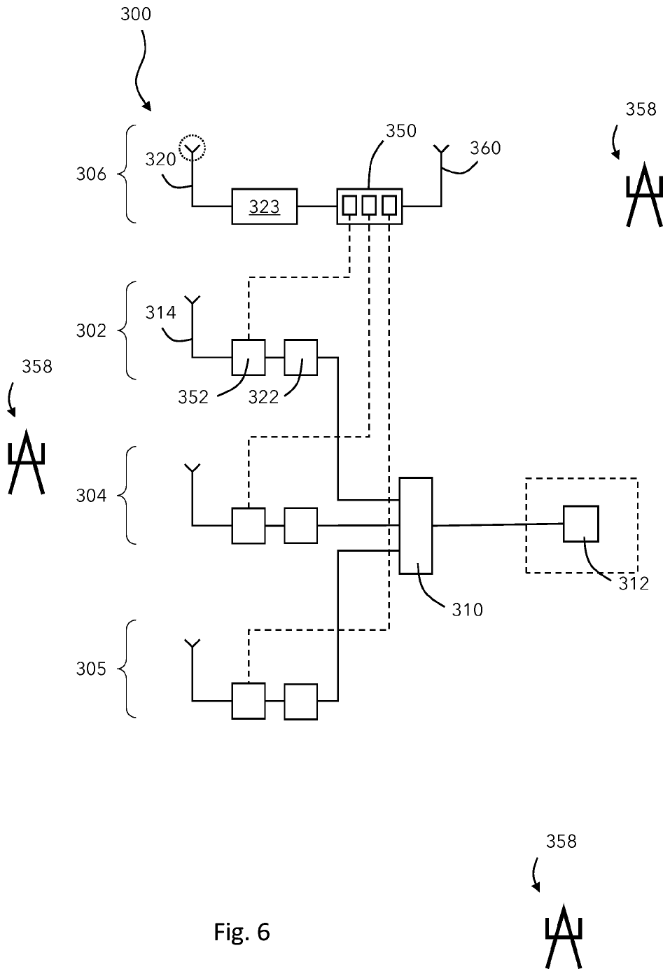

A system 100 according to the present invention is shown in FIGS. 5a to 5d. The system utilises dynamic switching for a multi-zone configuration

The system 100 comprises a first directional donor antenna sub-system 102, a second directional donor antenna sub-system 104, an omni-directional donor antenna sub-system 106, a switching sub-system 108, a first rebroadcast distributed antenna sub-system 110 and a second rebroadcast antenna sub-system 112.

The directional donor antenna sub-systems are substantially identical and as such only the sub-system 102 will be described in detail. The sub-system 102 comprises a plurality of a scanning antennas 114 and a plurality of a donor antennas 116 (where a ≥1). As with the applicant's prior patent EP 3 228 023 B1, the scanning antennas 114 and donor antennas 116 are directional. They are aligned such that each scanning antenna has a respective paired donor antenna. The scanning antennas cycle to determine the best signal, and on that basis a suitable donor antenna is selected for connection to a power amplifier 118.

Unlike EP 3 228 023 B1, the directional donor antenna of the sub-system 102 is continuously feeding the first rebroadcast distributed antenna sub-system 110 with the respective donor radio base station signal available at its coverage sector area, until such a donor radio base station signal is no longer available for re-transmission, where under this condition, the first rebroadcast distributed antenna sub-system 110 switches donor to the omni-directional donor antenna sub-system 106.

The omni-directional donor antenna sub-system 106 comprises an omni-directional antenna 120 (covering 360 degrees) and a power amplifier 122.

The switching sub-system has a plurality of n directional donor inputs 124, a master input 126, and a plurality of m rebroadcast antenna outputs 128.

Each input 124 is connected to an input switch 130. Each input switch 130 comprises an input 132 and two outputs 134, 136. The latter output 134 is connected to a dummy load 138.

The master input 126 is connected to a master input splitter 139 having a single input 140 and a plurality of m outputs 142. Each output 142 is connected to a respective master dummy load switch 144, having one input 146 and two outputs 148, 150. The input 146 is connected to the master input splitter 139, the outputs 148 is connected to a dummy load 152.

The switching sub-system further comprises a plurality of m rebroadcast switches 154 each having a first input 156, a second input 158 and single output 160. The first input 156 is connected to an output 148 of one of the master dummy load switches 144. The second input 158 is fed from one of the respective input switches 130. The output 160 is connected to a respective rebroadcast antenna outputs 128.

Each rebroadcast antenna sub-system 110, 112 comprises a plurality of rebroadcast antennas 162. Each sub-system 110, 112 covers a discrete, non-overlapping area of the vehicle 110′, 112′ (in this case the ship of FIG. 5b).

### Use

Referring to FIG. 5c, the system 100 is shown in a first state, in which each of the donor antenna sub-systems 102, 104 has located a donor radio base station and is passing a receivable signal via the power amplifier 118, through the input switch 130, through the rebroadcast switch 154 to the rebroadcast antenna sub-system 110. Because each donor directional antenna 116 covers a different sector area, each is in communication with a different donor radio base station. In this state, each output from the splitter 139 is connected to its dummy load.

If one of the directional donor antenna sub-systems cannot locate a suitable donor radio base station, the antennas are switched to the dummy load 138. Referring to FIG. 5d, the system 100 is shown in a second state, in which only the donor antenna sub-system 102 has located a base station and is passing a signal via the power amplifier 118, through the input switch 130, through the rebroadcast switch 154 to the rebroadcast antenna sub-system 110. The system 104 has not located a suitable base station (or the signal received does not meet the predetermined conditions). Therefore switches 130, 154 and 144 all change to connected the omnidirectional antenna 120 and its power amplifier 122 to the rebroadcast antenna sub-system 106. In this state, the directional antenna sub-system 104 is connected to its dummy load.

The master dummy load switch 144 is then connected to the splitter output, which connects the omni-directional antenna sub-system 106 to the rebroadcast antenna 112.

Any number from 1 to m of the rebroadcast antennas may be connected to the omnidirectional antenna.

### Description of the Fifth Embodiment

A system 300 according to the present invention is shown in FIG. 6.

### Configuration

The system 300 comprises a first directional donor antenna sub-system 302, a second directional donor antenna sub-system 304, a third directional donor antenna sub-system 305, an omni-directional scanning antenna sub-system 306, a controller 350, a bundling/bonding device 310 and a micro cell 312.

The directional donor antenna sub-systems are substantially identical and as such only the sub-system 302 will be described. The sub-system 302 comprises a steerable directional antenna 314 having an actuator 352 configured to steer the antenna (in this embodiment) via electromechanical actuator in the azimuth plane. Each of the antennas is a directional antenna of narrow −3 dB horizontal beamwidth. Antennas could be S-Pol, X-pol, MIMO, massive-MIMO, active, multiband and the like.

The antenna 314 can be steered, in this embodiment, through 360 degrees. Each antenna 314 is connected to a wireless modem 322.

The omni-directional scanning antenna sub-system 306 is substantially as described above for sub-system 206 although features are numbered 100 greater.

The controller 350 receives an input from the device 323 and is configured to control each of the actuators 352.

Instead of aggregating the signals from the antennas via non-overlapping regions of the hotspot, this embodiment provides the outputs from each wireless modem 322 into a bundling or bonding device 310 which aggregates the signals and provides an output to, in this case, a micro-cell 312 providing LTE/5G/6G coverage across the hotspot.

In this embodiment, the system acts as a backhauling system to allow implementation of a micro-cell. This may be useful e.g., on a vehicle where it is not possible to install a wired connection to the network.

### Variations in the Fifth Embodiment

The antennas 314 may be configured to receive LTE/5G/6G signals, or Wi-Fi. Further, the micro-cell 312 may be replaced with and access point, which may be wired or wireless.

### Variations

It will be noted that although a system is described having two directional donor sub-systems and two rebroadcast sub-systems, any number of each can be provided. For example there may be n donor sub-systems and n rebroadcast systems, or n donor sub-systems and m rebroadcast systems, where n>1, m>1 and n≠m.

In the second embodiment, more than one omnidirectional antenna 220 may be used, for example for multiple donor networks.

Further, the embodiments may be combined such that the system 200 is configured to fall back to service provision via an omnidirectional antenna if one or several of the directional antennas cannot be assigned a suitable RBS. The omnidirectional antenna may be the antenna or antenna 220 (i.e. the scanning antenna), or a separate dedicated omnidirectional antenna.

The directional antennas may have 360 degree coverage or their range of motion may be limited, for example to non-overlapping sectors.

In the above embodiments, coverage is provided by non-overlapping (or minimally overlapping) but adjacent areas of the hotspot. In another embodiment, the rebroadcast antennas or access points may be configured to provide rebroadcast signals on different frequencies, allowing the area of coverage to partially or completely overlap.

1. A multi-directional antenna system for a hotspot, the system comprising:
a plurality of directional donor antennas, each antenna oriented in a different direction such that each antenna has a different dominant radio base station in use;
a plurality of intermediary devices;
wherein:
each directional donor antenna is connected to a respective different intermediary device; and,
each intermediary device is configured to retransmit the respective signals of each different dominant radio base station to provide service to a plurality of users within the hotspot.

2. (canceled)

3. The multi-directional antenna system according to claim 1, wherein the intermediary devices are repeaters, and each of the plurality of repeaters is connected to a respective rebroadcast antenna or distributed antenna system, wherein each rebroadcast antenna or distributed antenna system covers a different area of the hotspot.

4. (canceled)

5. The multi-directional antenna system according to claim 1, wherein the intermediary devices are modems, and each of the plurality of modems is connected to a respective access point, wherein each access point covers a different area of the hotspot.

6. The multi-directional antenna system according to claim 5, wherein each of the plurality of modems is connected to a respective access point, wherein each access point covers an at least partially overlapping of the hotspot, and each access point is configured to broadcast at a distinct frequency.

7. The multi-directional antenna system according to claim 1, wherein:
the radiation pattern of each of the directional donor antennas is configured to be independently steered; or
each of the directional donor antennas is configured to be independently steered.

8. (canceled)

9. The multi-directional antenna system according to claim 7, comprising a controller configured to control each of the directional donor antennas to direct each to a different radio base station.

10. The multi-directional antenna system according to claim 1, comprising:
a scanning antenna, the scanning antenna configured to identify a suitable radio base station for each of the plurality of directional donor antennas to connect to.

11. The multi-directional antenna system according to claim 10 wherein the scanning antenna is an omnidirectional antenna.

12-16. (canceled)

17. The multi-directional antenna system according to claim 1, comprising:
an omnidirectional donor antenna; and,
a switching sub-system configured to switch at least one of the intermediary devices between its respective directional donor antenna and the omnidirectional donor antenna.

18-21. (canceled)

22. A method of operating a multi-directional antenna system for a hotspot comprising the steps of:
providing a plurality of directional donor antennas and a plurality of intermediary devices;
connecting each directional donor antenna to a respective different intermediary device;
using each of the plurality of directional donor antennas to target a different dominant radio base station;
using the intermediary devices to amplify and retransmit each respective different radio base station to provide service to a plurality of users within a hotspot.

23. (canceled)

24. The method according to claim 22, wherein the intermediary devices are repeaters, and each of the plurality of repeaters is connected to a respective rebroadcast antenna or distributed antenna system, wherein each rebroadcast antenna or distributed antenna system covers a different area of the hotspot.

25. (canceled)

26. The method according to claim 22, wherein the intermediary devices are modems, and each of the plurality of modems is connected to a respective access point, wherein each access point covers a different area of the hotspot.

27. (canceled)

28. The method according to claim 22, comprising the step of:
steering the radiation pattern of at least one of the directional donor antennas; or
steering at least one of the directional donor antennas.

29-30. (canceled)

31. The method according to claim 22, comprising the steps of:
providing a scanning antenna;
using the scanning antenna to identify a suitable radio base station for each of the plurality of directional donor antennas to connect to.

32. The method according to claim 31 wherein the scanning antenna is an omnidirectional antenna.

33-37. (canceled)

38. The method according to claim 22, comprising the steps of:
providing an omnidirectional donor antenna; and,
switching at least one of the intermediary devices between its respective directional donor antenna and the omnidirectional donor antenna.

39-42. (canceled)

43. A cellular antenna repeater system for a vehicle, the system comprising a plurality of directional donor antenna sub-systems, each oriented in a different direction such that each directional donor antenna sub-system has a different dominant radio base station in use,
wherein each directional donor antenna sub-system is connected to a respective rebroadcast antenna sub-system, wherein the re-broadcast antenna sub-systems each cover a different area of the vehicle.

44. The cellular antenna repeater system according to claim 43, wherein the areas of the vehicle do not overlap.

45. The system according to claim 43, comprising:
an omnidirectional donor antenna sub-system; and,
a switching sub-system configured to switch at least one of the rebroadcast antenna sub-systems between the respective directional donor antenna sub-system and the omnidirectional donor antenna sub-system.

46. The system according to claim 45, wherein the switching sub-system is configured to switch each of the rebroadcast antenna sub-systems between the respective directional donor antenna sub-system and the omnidirectional donor antenna sub-system.

47-54. (canceled)
